(19) United States
(12) Patent Application Publication
(10) Pub. No.: US 2024/0303044 A1
(43) Pub. Date: Sep. 12, 2024

(54) FRAMEWORK FOR GENERATION OF ARCHITECTURE MODELS BASED ON DOMAIN SPECIFIC LANGUAGE AND TRACKING ARCHITECTURE DRIFT

(71) Applicant: JPMorgan Chase Bank, N.A., New York, NY (US)

(72) Inventors: Sunder RAMMURTHY, Thane (IN); Ketan Gopal SHIRODKAR, Thane (IN); Venkateswarlu YADAVALLI, Hyderabad (IN)

(73) Assignee: JPMorgan Chase Bank, N.A., New York, NY (US)

(21) Appl. No.: 18/136,506

(22) Filed: Apr. 19, 2023

(30) Foreign Application Priority Data
Mar. 6, 2023 (IN) 202311015043

(51) Int. Cl. G06F 8/20; G06F 8/35

(52) U.S. Cl. CPC G06F 8/20; G06F 8/35

(57) ABSTRACT

A method and a system for automatic generation of application architecture models and tracking of architecture drift are provided. The present solution provides a framework that allows a centralized architecture team to create a base Domain Specific Language (base-DSL) for any software application, where this base-DSL includes basic components that may be required to generate a model for any application. The framework of the present disclosure also provides a means to enrich base-DSLs for any specific application to generate application-specific DSL. Further, the framework provides a visual interface for product architects to create a to-be or progressive state architecture using the application-specific DSL. The framework is also able to generate a current state architecture of an application using application metadata and application-specific DSL. The framework is also able to detect architecture drifts between current and to-be or progressive architecture states of an application.

### CROSS-REFERENCE TO RELATED APPLICATIONS

This application claims priority benefit from Indian application No. 202311015043, filed on Mar. 6, 2023 in the India Patent Office, which is hereby incorporated by reference in its entirety.

### BACKGROUND

### Field of the Disclosure

This technology generally relates to methods and systems for generating models for visualizing software architecture, and more particularly to methods and systems for auto-generation of application architecture models and tracking of architecture drift.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Architecture diagrams of a software application show the software application's progressive order of events. They may include a variety of elements that illustrate occurrence of various events or interactions between or within various elements of the software application, at different points in time. In other words, the architecture diagrams refer to fundamental structures of the software application and discipline of creating such structures. Each structure may include software elements, relations between them, and properties of both the structures and their relations. Thus, the architecture diagrams provide a better understanding of the structure of the software application by presenting a visual depiction of the software application for a user.

The software architecture of the software application or a product evolves and changes over a period of time due to various reasons such as changes introduced in market, new requirements of the market, changes to business processes, technology advances, among other things. It is currently a challenge to keep up with a consistent architectural state representing current and to-be models of the software application or the product at a point in time, thus making it difficult to detect drifts between a proposed architecture and a current state architecture of the software application.

Currently, various modelling frameworks for understanding and creating software architectures are available. For example, a C4 modelling framework describes or defines software architecture at different levels of details such as context, containers, components, and codes. However, the capability to automatically generate such C4 models intelligently for a given software application's current state architecture does not exist, and the exercise of creating such C4 models for any application is thus, done manually. This manual exercise is extremely cumbersome, especially for complex software applications with numerous features, and changing (e.g., adding or deleting) even a small feature from such software applications requires a lot of effort in modification of the software architecture. Also, the exercise has to be done manually every time there are changes in the software application. Further, there is no existing solution that may represent the current state architecture of the software application at a transition stage, and calculate an architecture drift of the software application or product with respect to its to-be state or progressive state architecture.

Thus, there exists a need to develop a solution for auto-generation of architecture models of the software application and tracking of the architecture drift. The solution should intelligently generate and maintain architecture design for the current state architecture of the software application or the product using modelling sourcing from various system of records, and also detect the architecture drifts between the current state architecture and the to-be state or progressive state architecture of the software application.

### SUMMARY

The present disclosure, through one or more of its various aspects, embodiments, and/or specific features or sub-components, provides, inter alia, various systems, servers, devices, methods, media, programs, and platforms for auto-generation of application architecture models and tracking of architecture drift.

According to an aspect of the disclosure, a method for generating an application-specific DSL for an application is disclosed. The method is implemented by at least one processor. The method may include loading, by the at least one processor at a visualizer, a set of base-Domain Specific Language (DSL) components from a repository; receiving, by the at least one processor at the visualizer, a first user input; creating, by the at least one processor at the visualizer, a set of application-specific components based on the set of base-DSL components and the first user input; and transforming, by the at least one processor via a DSL transformer, the set of application-specific components into a set of application-specific DSL components for the application.

According to another aspect of the disclosure, a method for generating a progressive state architecture of an application is disclosed. The method is implemented by at least one processor. The method may include loading, by the at least one processor at a visualizer, a set of application-specific DSL components from a repository, wherein the set of application-specific DSL components are associated with the application; creating, by the at least one processor at the visualizer, a visual representation of the progressive state architecture based on a second user input and the set of application-specific DSL components associated with the application; transforming, by the at least one processor via a model transformer, the visual representation of the progressive state architecture into a set of model objects; and generating, by the at least one processor via a model generator, the progressive state architecture of the application based on the set of model objects.

In accordance with an exemplary embodiment, the generating the progressive state architecture of the application based on the set of model objects may include converting the set of model objects into a Diagram as Code (“DaC”).

In accordance with an exemplary embodiment, the method for generating the progressive state architecture of the application further may include converting, by the at least one processor via a DaC transformer, the DaC into a first target DaC.

According to another aspect of the disclosure, a method for generating a current state architecture of an application is disclosed. The method is implemented by at least one processor. The method may include receiving periodically, by the at least one processor at a model transformer from at least one software inventory system, an application metadata associated with the application; fetching, by the at least one processor via the model transformer from a repository, an application-specific Domain Specific Language (DSL) for the application; transforming, by the at least one processor via the model transformer, the application metadata into a set of model objects based on the application-specific DSL; and generating, by the at least one processor via a model generator, the current state architecture of the application based on the set of model objects.

In accordance with an exemplary embodiment, the generating the current state architecture of the application based on the set of model objects may include converting the set of model objects into a Diagram as Code (“DaC”).

In accordance with an exemplary embodiment, the method for generating the current state architecture of the application further may include converting, by the at least one processor via a DaC transformer, the DaC into a second target DaC.

According to another aspect of the disclosure, a method for determining a progressive architecture drift between a current state architecture of an application and a progressive state architecture of the application is disclosed. The method is implemented by at least one processor. The method may include receiving, by the at least one processor via a model generator from a repository, the progressive state architecture for the application; comparing, by the at least one processor via the model generator, the progressive state architecture and the current state architecture; and identifying, by the at least one processor via the model generator, the progressive architecture drift between the current state architecture and the progressive state architecture of the application based on the comparison.

According to another aspect of the present disclosure, a computing device configured to implement an execution of a method for creating an application-specific DSL for an application is disclosed. The computing device comprises: a processor; a memory; and a communication interface coupled to each of the processor and the memory. The processor may be configured to: load, at a visualizer, a set of base-Domain Specific Language (DSL) components from a repository; receive, at the visualizer, a first user input; create, at the visualizer, a set of application-specific components based on the set of base-DSL components and the first user input; and transform, via a DSL transformer, the set of application-specific components into a set of application-specific DSL components for the application.

According to another aspect of the present disclosure, a computing device configured to implement an execution of a method for generating a progressive state architecture of an application is disclosed. The computing device comprises: a processor; a memory; and a communication interface coupled to each of the processor and the memory. The processor may be configured to: load, at a visualizer, a set of application-specific DSL components from a repository, wherein the set of application-specific DSL components are associated with the application; create, at the visualizer, a visual representation of the progressive state architecture based on a second user input and the set of application-specific DSL components associated with the application; transform, via a model transformer, the visual representation of the progressive state architecture into a set of model objects; and generate, via a model generator, the progressive state architecture of the application based on the set of model objects.

In accordance with an exemplary embodiment, the processor may be further configured to generate, via the model generator, the progressive state architecture of the application based on the set of model objects by converting the set of model objects into a Diagram as Code (“DaC”).

In accordance with an exemplary embodiment, the processor may be further configured to convert, via a DaC transformer, the DaC into a first target DaC.

According to another aspect of the present disclosure, a computing device configured to implement an execution of a method for generating a current state architecture of an application is disclosed. The computing device comprises: a processor; a memory; and a communication interface coupled to each of the processor and the memory. The processor may be configured to: receive periodically, at a model transformer from at least one software inventory system, an application metadata associated with the application; fetch, via the model transformer from a repository, an application-specific DSL for the application; transform, via the model transformer, the application metadata into a set of model objects based on the application-specific DSL; and generate, via a model generator, the current state architecture of the application based on the set of model objects.

In accordance with an exemplary embodiment, the processor may be further configured to generate, via the model generator, the current state architecture of the application based on the set of model objects by converting the set of model objects into a Diagram as Code (“DaC”).

In accordance with an exemplary embodiment, the processor may be further configured to convert, via a DaC transformer, the DaC into a second target DaC.

According to another aspect of the present disclosure, a computing device configured to implement an execution of a method for determining a progressive architecture drift between a current state architecture and a progressive state architecture of an application is disclosed. The computing device comprises: a processor; a memory; and a communication interface coupled to each of the processor and the memory. The processor may be configured to: receive, via a model generator from a repository, the progressive state architecture for the application; compare, via the model generator, the progressive state architecture and the current state architecture; and identify, via the model generator, the progressive architecture drift between the current state architecture and the progressive state architecture of the application based on the comparison.

According to another aspect of the present disclosure, a non-transitory computer-readable storage medium storing instructions for generating an application-specific DSL for an application is disclosed. The instructions include executable code which, when executed by a processor, may cause the processor to: load, at a visualizer, a set of base-Domain Specific Language (DSL) components from a repository; receive, at the visualizer, a first user input; create, at the visualizer, a set of application-specific components based on the set of base-DSL components and the first user input; and transform, via a DSL transformer, the set of application-specific components into a set of application-specific DSL components for the application.

According to another aspect of the present disclosure, a non-transitory computer-readable storage medium storing instructions for generating a progressive state architecture of an application is disclosed. The instructions include executable code which, when executed by a processor, may cause the processor to: load, at a visualizer, a set of application-specific DSL components from a repository, wherein the set of application-specific DSL components are associated with the application; create, at the visualizer, a visual representation of the progressive state architecture based on a second user input and the set of application-specific DSL components associated with the application; transform, via a model transformer, the visual representation of the progressive state architecture into a set of model objects; and generate, via a model generator, the progressive state architecture of the application based on the set of model objects.

According to another aspect of the present disclosure, a non-transitory computer-readable storage medium storing instructions for generating a current state architecture of an application is disclosed. The instructions include executable code which, when executed by a processor, may cause the processor to: receive periodically, at a model transformer from at least one software inventory system, an application metadata associated with the application; fetch, via the model transformer from a repository, an application-specific DSL for the application; transform, via the model transformer, the application metadata into a set of model objects based on the application-specific DSL; and generate, via a model generator, the current state architecture of the application based on the set of model objects.

According to yet another aspect of the present disclosure, a non-transitory computer-readable storage medium storing instructions for determining a progressive architecture drift between a current state architecture and a progressive state architecture of an application is disclosed. The instructions include executable code which, when executed by a processor, may cause the processor to: receive, via a model generator from a repository, the progressive state architecture for the application; compare, via the model generator, the progressive state architecture and the current state architecture; and identify, via the model generator, the progressive architecture drift between the current state architecture and the progressive state architecture of the application based on the comparison.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary computer system for auto-generation of application architecture models and tracking of architecture drift, in accordance with an exemplary embodiment.

FIG. 2 illustrates an exemplary diagram of a network environment for auto-generation of application architecture models and tracking of architecture drift, in accordance with an exemplary embodiment.

FIG. 3 shows an exemplary system for auto-generation of application architecture models and tracking of architecture drift, in accordance with an exemplary embodiment.

FIG. 4 is a flowchart of an exemplary process for creating an application-specific DSL for an application, in accordance with an exemplary embodiment.

FIG. 5 is a flowchart of an exemplary process for generating a progressive state architecture of an application, in accordance with an exemplary embodiment.

FIG. 6 is an exemplary process for generating a current state architecture of an application, in accordance with an exemplary embodiment.

FIG. 7 is a flowchart of an exemplary process for determining a progressive architecture drift between a current state architecture and a progressive state architecture of an application, in accordance with an exemplary embodiment.

FIG. 8 is a high-level data flow diagram for the framework, in accordance with an exemplary embodiment.

FIG. 9 is an exemplary current state architecture generated by the framework, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units and/or controllers described and depicted in the figures include the software or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the invention. It will be apparent however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable storage medium having instructions stored thereon for one or more aspects of the present disclosure as described and illustrated by way of the examples herein. The instructions in some examples include executable code that, when executed by one or more processors, cause the processors to carry out steps necessary to implement the methods of the examples of this disclosure that are described and illustrated herein.

To overcome problems associated with intelligently generating and maintaining architecture design for a current state architecture of software applications or products using modelling sourcing from various system of records, and to overcome problems associated with representing the current state architecture of the software applications or the products at various transition stages, and calculating an architecture drift of the software applications or the products with respect to its to-be or progressive state architecture, the present disclosure provides a method and a system for an automatic generation of the current state architecture of the software applications and the progressive state architecture of the software applications and tracking of the architecture drift. The present disclosure provides a framework that allows a user such as a centralized architecture team to create a base Domain Specific Language (base-DSL) for a software application, wherein this base-DSL includes basic components or base-DSL components that may be required to generate a model for said software application. For instance, the base-DSL components may include a web server(s), a repository (or “repositories”), etc. Further, the framework of the present disclosure also provides a means to enrich the base-DSL components for the software application to generate application-specific DSL. Further, the framework of the present disclosure provides a visual interface for a product architect to create a to-be or progressive state architecture of the software application using the application-specific DSL. The framework proposed in the present disclosure is also configured to generate a current state architecture of the software application using an application metadata and the application-specific DSL. The framework is also configured to detect an architecture drift between the current state architecture of the software application and the to-be or progressive state architecture of the software application.

Example embodiments of the present disclosure are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each functional block, unit, and/or module may be implemented by a dedicated hardware, or as a combination of the dedicated hardware to perform some functions and a processor (e.g., at least one programmed microprocessor and associated circuitry), to perform other functions. Also, each functional block, unit, and/or module of the example embodiments may be physically separated into two or more interacting and discrete functional blocks, units, and/or modules without departing from the scope of the inventive concepts. Further, the functional blocks, units, and/or modules described with reference to the example embodiments of the present disclosure, may be physically combined into more complex functional blocks, units or modules without departing from the scope of the present disclosure.

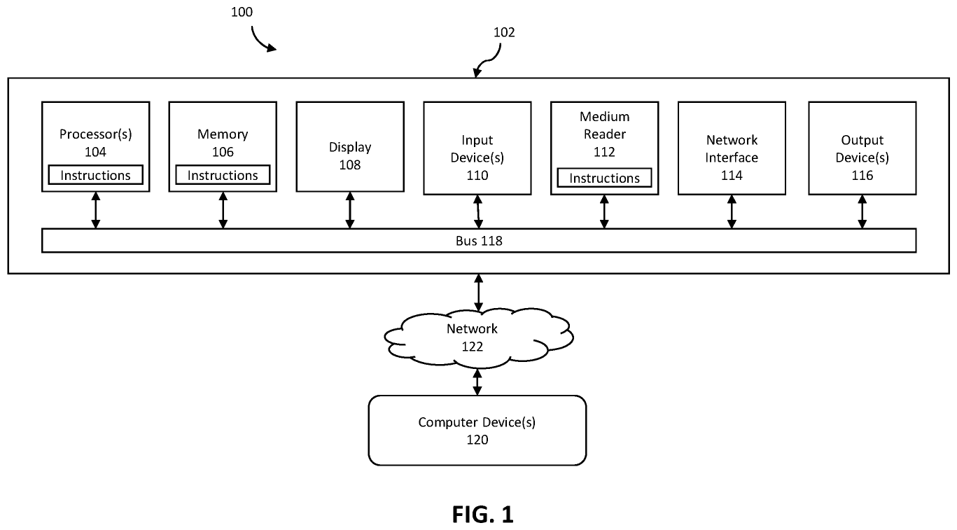

FIG. 1 is an exemplary system for use in accordance with the embodiments described herein. The system 100 is generally shown and may include a computer system 102, also known as computing device 102, which is generally indicated to perform various methods as described herein, in accordance with an exemplary embodiment.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of the memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but is not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but is not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer (PC). However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

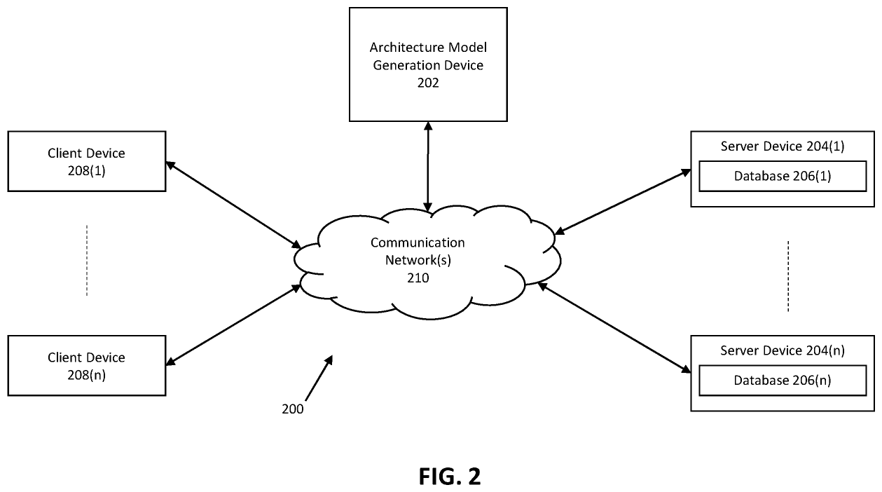

Referring to FIG. 2, a schematic of an exemplary network environment 200 for implementing various methods described herein in accordance with an exemplary embodiment. In an exemplary embodiment, the method is executable on any networked computer platform, such as, for example, a personal computer (PC).

The methods described herein may be implemented by an Architecture Model Generation (AMG) device 202. The AMG device 202 may be the same or similar to the computer system 102 as described with respect to FIG. 1. The AMG device 202 may store one or more applications that can include executable instructions that, when executed by the AMG device 202, cause the AMG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AMG device 202 itself, may be located in virtual server(s) running in a cloud-based computing environment rather than being tied to one or more specific physical network computing devices. Also, the application(s) may be running in one or more virtual machines (VMs) executing on the AMG device 202. Additionally, in one or more embodiments of this technology, virtual machine(s) running on the AMG device 202 may be managed or supervised by a hypervisor.

In the network environment 200 of FIG. 2, the AMG device 202 is coupled to a plurality of server devices 204(1)-204(n) that hosts a plurality of databases or repositories 206(1)-206(n), and also to a plurality of client devices 208(1)-208(n) via communication network(s) 210. A communication interface of the AMG device 202, such as the network interface 114 of the computer system 102 of FIG. 1, operatively couples and communicates between the AMG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AMG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable storage media, and AMG device 202 that efficiently implement the various methods described herein, the methods being implemented by at least one processor.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AMG device 202 may be a standalone device or integrated with one or more other devices or computing device, such as one or more of the server devices 204(1)-204(n), for example. In one particular example, the AMG device 202 may include or be hosted by one of the server devices 204(1)-204(n), and other arrangements are also possible. Moreover, one or more of the devices of the AMG device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AMG device 202 via the communication network(s) 210 according to the Hypertext Transfer Protocol (HTTP) based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the repositories or databases 206(1)-206(n) that are configured to store information, instructions, procedures, files that are needed for implementing the methods described herein.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AMG device 202 via the communication network(s) 210. Client device in this context refers to any computing device that interfaces to the communications network(s) 210 to obtain resources from one or more server devices 204(1)-204(n) or other client devices 208(1)-208(n). According to exemplary embodiments, the client devices 208(1)-208(n) in this example may include any type of computing device that can facilitate the implementation of the AMG device 202 that may be configured for implementing the methods described herein, but the disclosure is not limited thereto. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, eg., a smartphone.

The client devices 208(1)-208(n) may run interface applications, such as standard web browsers or standalone client applications, which may provide an interface to communicate with the AMG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AMG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AMG device 202, the server devices 204(1)-204(n), or the client devices 208(1)-208(n), for example, may be configured to operate as virtual instances on the same physical machine. In other words, one or more of the AMG device 202, the server devices 204(1)-204(n), or the client devices 208(1)-208(n) may operate on the same physical device rather than as separate devices communicating through the communication network(s) 210. Additionally, there may be more or fewer AMG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

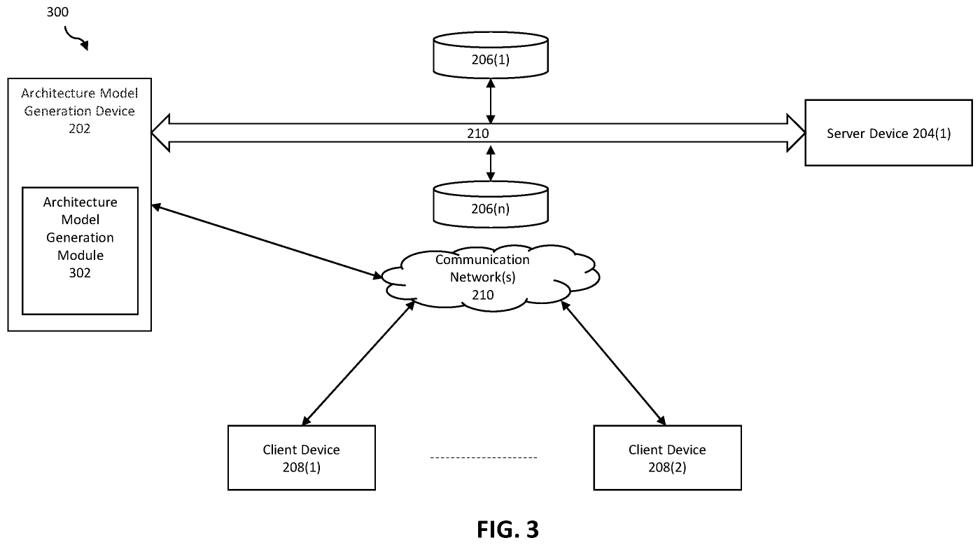

FIG. 3 illustrates an exemplary system for implementing the various methods described herein, in accordance with an exemplary embodiment. As illustrated in FIG. 3, according to exemplary embodiments, the system 300 may include the AMG device 202 including an Architecture Model Generation (AMG) module 302 that may be connected to the server device 204(1) and one or more repository 206(1) . . . 206(n) via the communication network 210, but the disclosure is not limited thereto. The AMG device 202 may also be connected to the plurality of client devices 208(1)-208(n) via the communication network 210, but the disclosure is not limited thereto. According to exemplary embodiments, the AMG device 202 may be implemented within the client devices 208(1)-208(n), but the disclosure is not limited thereto. According to exemplary embodiments, the client devices 208(1)-208(n) may be utilized for implementing software application process(es) and machine learning model generations, but the disclosure is not limited thereto.

The AMG device 202 is described and shown in FIG. 3 as including the Architecture Model Generation (AMG) module 302, although it may include other rules, policies, modules, repositories or databases, or applications, for example. As will be described below, the AMG module 302 is configured to implement the various methods described herein.

An exemplary process for implementing the various methods described herein by utilizing the network environment of FIG. 2 is shown as being executed in FIG. 3. Specifically, the first client device 208(1) and the second client device 208(2) are illustrated as being in communication with the AMG device 202. In this regard, the first client device 208(1) and the second client device 208(2) may be “clients” of the AMG device 202 and are described herein as such. Nevertheless, it is to be known and understood that the first client device 208(1) or the second client device 208(2) or both, need not necessarily be “clients” of the AMG device 202, or any entity described in association therewith herein. Any additional or alternative relationship may exist between either or both of the first client device 208(1) and the second client device 208(2) and the AMG device 202, or no relationship may exist.

Further, the AMG device 202 is illustrated as being able to access the one or more repositories 206(1) . . . 206(n). The AMG module 302 may be configured to access these repositories or databases for implementing the various methods described herein. The first client device 208(1) may be, for example, a smartphone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the AMG device 202 via a broadband or a cellular communication. Of course, these embodiments are merely exemplary and are not limiting or exhaustive.

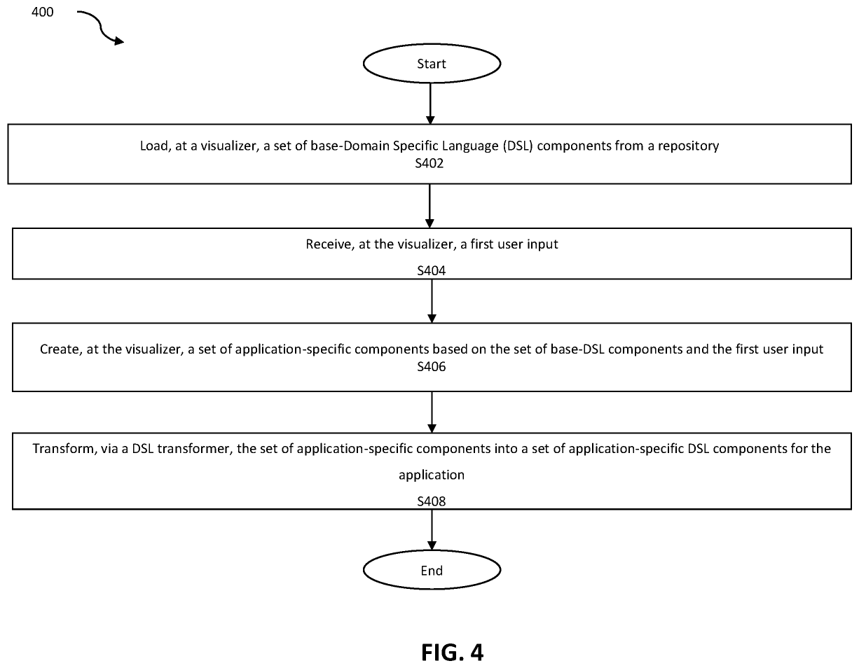

Upon being started, the AMG module 302 executes the various methods described herein. An exemplary flow diagram for implementing the AMG module 302 of FIG. 3, to further implement these methods, in accordance with an exemplary embodiment is generally indicated in FIGS. 4, 5, 6 and 7.

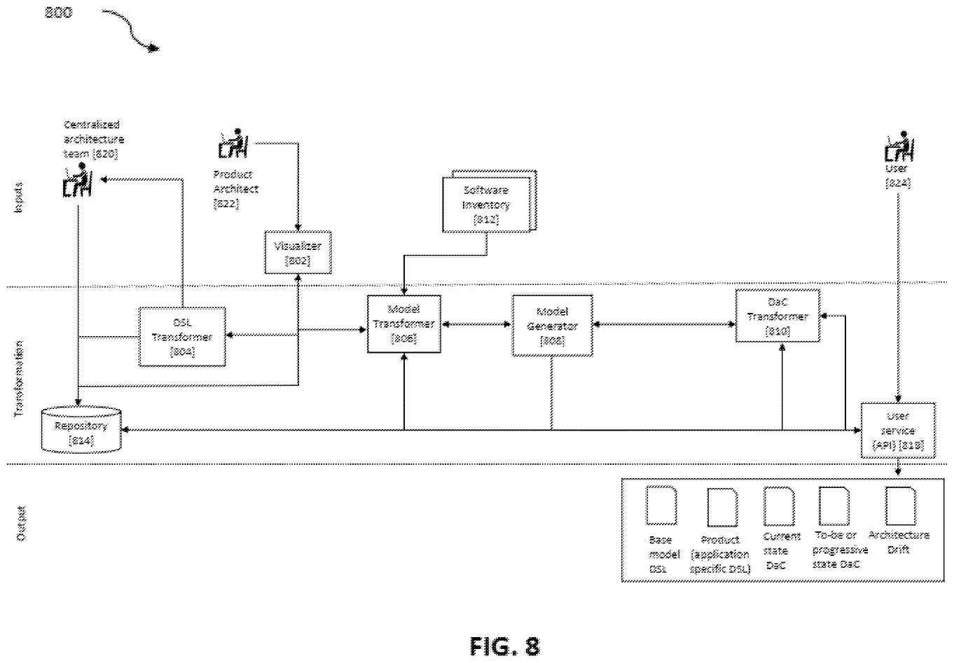

Referring also to FIG. 8, as also briefly discussed above, the present solution provides a framework that allows a user 824, such as the centralized architecture team, to create the base Domain Specific Language (base-DSL), wherein this base-DSL includes basic components that may be required to generate the model for any software application. For instance, the base-DSL components may include web server(s), repository (or repositories), etc. The base-DSL may be defined in any format such as Extensible Markup Language (XML) Schema Definition (XSD), JavaScript Object Notation (JSON), Yet Another Markup Language (YAML), etc. The base-DSL components act as a stencil or building blocks for generating software architecture models for any application.

Further, the present disclosure also provides a means to enrich the base-DSL for an application, and a process 400 to enrich the base-DSL for the application is disclosed in FIG. 4. As shown in FIG. 4, the process begins at step S402 where, a product architect may login to a visualizer 802 and a set of base-DSL components are loaded on the visualizer 802 from a repository 814. Thus, step S402 includes loading, by at least one processor 104 at the visualizer 802, the set of base-DSL components from the repository 814.

The step S404 includes receiving, by the at least one processor 104 at the visualizer 802, a first user input. The first user input may be an input from the product architect who wishes to create application-specific components. For instance, the product architect may import or drag and drop at least one base-DSL component into an editor at the visualizer 802 to create an application-specific component.

The step S406 includes creation of the application-specific components or objects. Based on the base-DSL components and the first user input from the product architect, the application-specific components or objects are created. Thus, step S406 may include creating, by the at least one processor 104 at the visualizer 802, a set of application-specific components based on the set of base-DSL components and the first user input. The application-specific components or objects may be specific to one application or one product or it may be specific to a product line.

Next, at step S408, the application-specific components or objects created at the visualizer 802 are converted to a DSL by a DSL transformer 804. Thus, the set of application-specific components are transformed into a set of application-specific DSL components by the DSL transformer 804. The set of application-specific DSL components are then stored in the repository 814 and could be re-used to generate architecture models for the specific application. In an implementation, the set of application-specific DSL components is approved by the centralized architecture team 820 prior to storing the same in the repository 814. The process then ends at step S408. As is evident from a description of FIG. 4, the present disclosure allows the product architect to create an application-specific DSL using a visual interface (e.g., the visualizer 802) by using the framework provided by the present disclosure.

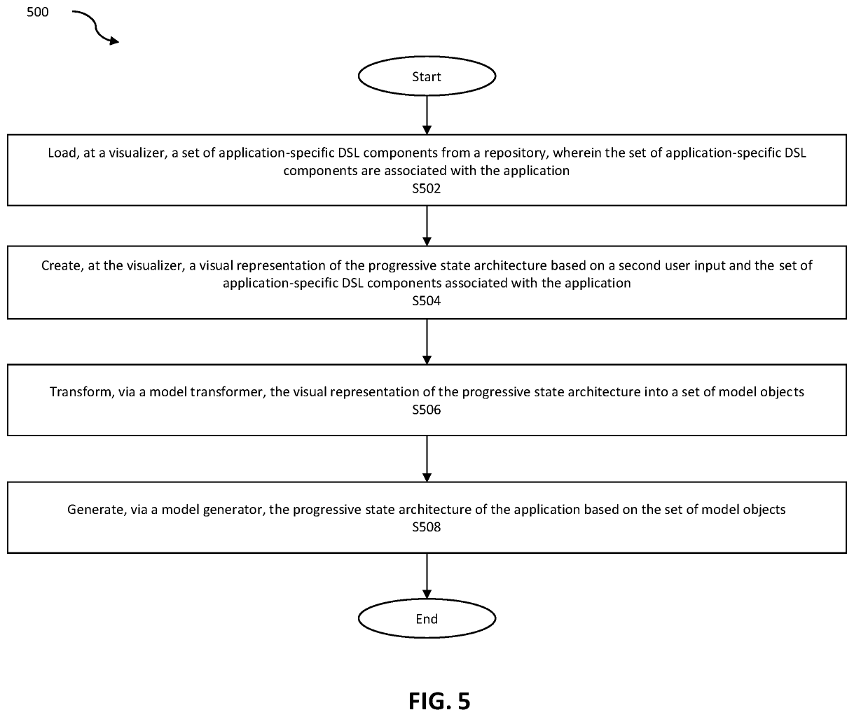

FIG. 5 illustrates a process 500 of generation of a progressive state architecture for an application, in accordance with exemplary embodiments of the present disclosure. As shown in FIG. 5, the process begins at step S502.

At step S502, a product architect may login to the visualizer 802 to create the progressive state architecture or model of the application. For this purpose, the product architect may access a ‘model creation’ section of the visualizer 802. A relevant application-specific DSL is then loaded at the visualizer 802 based on a selection made by the product architect. Thus, the product architect may choose or select the relevant application-specific DSL which is then further loaded into the visualizer 802. In an exemplary embodiment, various application-specific DSL entries or names (that have been previously stored in the repository 814) may be shown in a drop-down list at the visualizer 802, from which the product architect may select an application-specific DSL entry. The relevant application-specific DSL corresponding to the selected application-specific DSL entry may be loaded into the visualizer 802. This application-specific DSL is considered as a relevant application-specific DSL for which the product architect wishes to create the progressive state architecture. For instance, if the product architect wishes to create a progressive state architecture for a banking application, the product architect may select, among various options visible in the visualizer 802, an application-specific DSL for the specific banking application. Further, this selected or relevant application-specific DSL is loaded into the visualizer 802 by pulling such relevant application-specific DSL from the repository 814. Thus, step S502 may include loading, by the at least one processor 104 at the visualizer 802, a set of application-specific DSL components from the repository 814, wherein the set of application-specific DSL components are associated with the application for which the progressive state architecture is to be generated.

At step S504, a visual representation of the progressive state architecture is created based on the relevant application-specific DSL and a second user input from the product architect. Thus, the product architect, using the relevant application-specific DSL, creates the visual representation of the progressive state architecture of the application on the visualizer 802. The step S504 thus includes creating, by the at least one processor 104 at the visualizer 802, the visual representation of the progressive state architecture based on the second user input and the set of application-specific DSL components associated with the application. The second user input here is an input from the product architect as to how the progressive state architecture is intended to look like.

At step S506, the visual representation of the progressive state architecture created by the product architect is then provided as an input to the model transformer 806. The model transformer 806 then transforms the visual representation of the progressive state architecture into a set of model objects. In an exemplary implementation, the set of model objects may be Java objects or JSON objects. It may be appreciated by those skilled in the art that these model objects may be in any format and these examples do not limit the scope of this disclosure in any manner. This step, thus, includes transforming, by the at least one processor 104 via the model transformer 806, the visual representation of the progressive state architecture into the set of model objects.

At step S508, the progressive state architecture is generated based on the set of model objects. In this step, the set of model objects is provided as an input to a model generator 808 where the set of model objects is converted into a Diagram as Code (“DaC”). The DaC generated by the model generator 808 is then stored in the repository 814. Thereafter, the method ends at step S508. It may be appreciated by those skilled in the art that this method 500 may be used to generate a progressive state architecture for a new application or for an existing application.

The disclosure encompasses converting, by the at least one processor 104 via a DaC transformer 810, the Diagram as Code into a first target DaC. The first target DaC is any DaC that is specific to a third-party DaC tool.

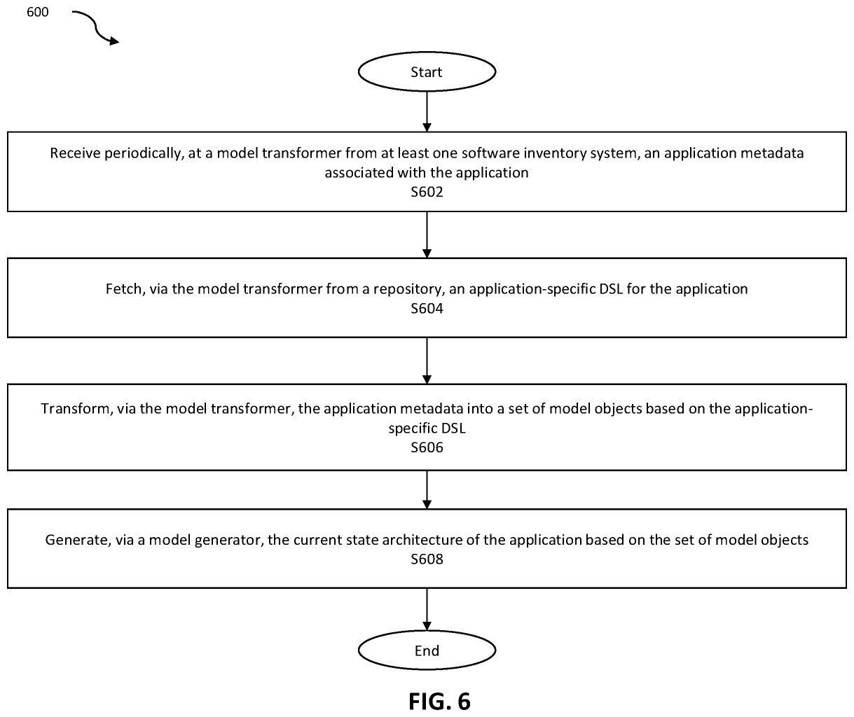

FIG. 6 illustrates a method 600 for generation of a current state architecture of an application, in accordance with exemplary embodiments of the present disclosure. As shown in FIG. 6, the method begins at step S602. At step S602, the method includes receiving periodically, by the at least one processor 104 at the model transformer 806 from at least one software inventory system 812, an application metadata associated with the application. In an embodiment, the application metadata is received periodically where the at least one software inventory system 812 itself pushes the application metadata at a regular interval or at an irregular interval of time. For example, the application metadata may include but is not limited to, an application identifier (ID), a name, a description, an application role(s), a module(s), a dependency (or dependencies), etc. Further, the application metadata may be different for different applications.

Further, at step S604, the model transformer 806 fetches, from the repository 814, an application-specific DSL. Thus, this step includes fetching, by the at least one processor 104 via the model transformer 806 from the repository 814, the application-specific DSL for the application.

Next, at step S606, the model transformer 806 transforms the application metadata into a set of model objects based on the application-specific DSL. Thus, this step includes transforming, by the at least one processor 104 via the model transformer 806, the application metadata into the set of model objects based on the application-specific DSL. The model transformer 806 then invokes the model generator 808.

At step S608, the model generator 808 generates the current state architecture of the application based on the set of model objects. This step includes generating, by the at least one processor 104 via the model generator 808, the current state architecture of the application based on the set of model objects. Essentially, generating the current state architecture includes converting the set of model objects (from step S606) into a Diagram as Code (‘DaC’). The DaC generated by the model generator 808 is then stored in the repository 814. Thereafter, the method ends at S608. This method 600 may be used to generate the current state architecture for an existing application.

The disclosure encompasses converting, by the at least one processor 104 via the DaC transformer 810, the Diagram as Code of the current state architecture into a second target DaC. The second target DaC is any DaC that is specific to the third-party DaC tool.

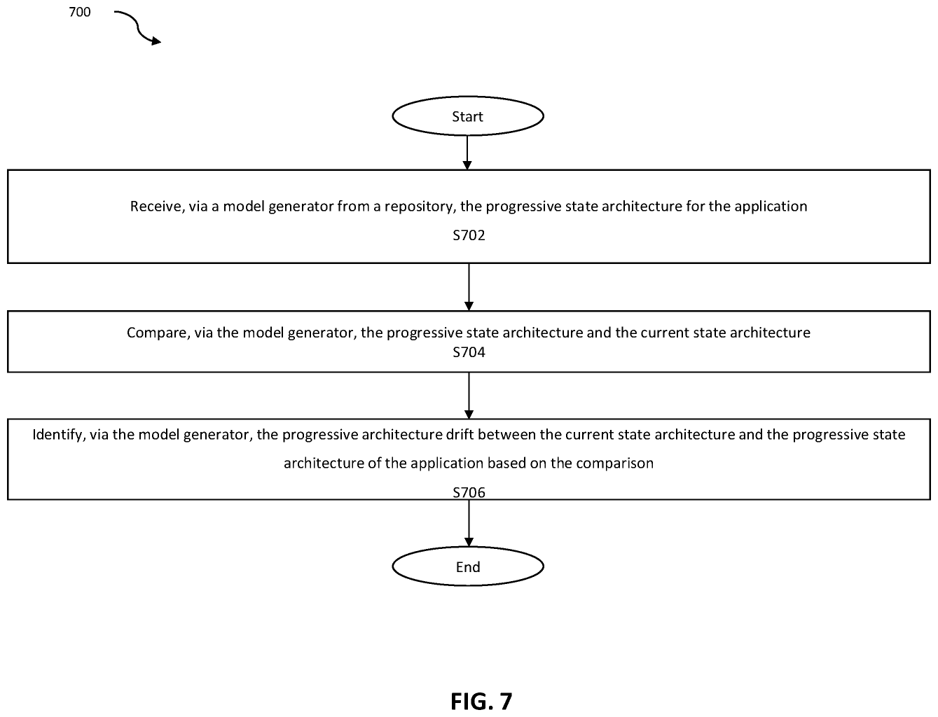

FIG. 7 illustrates a method 700 for determining a progressive architecture drift between a current state architecture and a progressive state architecture of an application. The method begins at step S702. At step S702, the method includes receiving, by the model generator 808, the progressive state architecture for the application from the repository 814. For example, the progressive state architecture DaC may be received by the model generator 808 from the repository 814. In an exemplary implementation, the model generator 808 pulls the progressive state architecture DaC of that specific application for which the model generator 808 has generated the current state architecture. In another exemplary implementation, the model generator 808 pulls the progressive state architecture DaC and the current state architecture DaC of any specific or same application from the repository 814.

At step S704, the method includes comparing, by the model generator 808, the progressive state architecture and the current state architecture. Thus, this step involves comparing the current state architecture DaC and the progressive state architecture DaC.

Next, at step S706, the method includes identifying, by the model generator 808, the progressive architecture drift based on the comparison of the current state architecture DaC and the progressive state architecture DaC. A difference between the current state architecture DaC and the progressive state architecture DaC is calculated by the model generator 808. This difference as calculated or detected by the model generator 808 pertains to design or the progressive architecture drift in the current state architecture and the to-be/progressive state architecture. This progressive architecture drift after being generated may be saved in the repository 814. Thereafter, the method ends at S706.

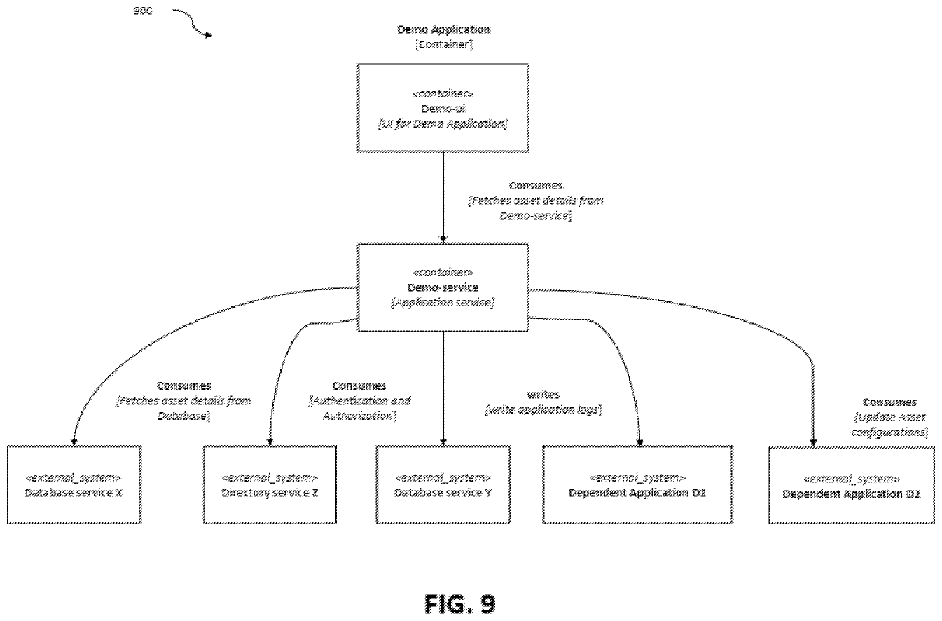

The present disclosure also encompasses converting, by the DaC transformer 810, the DaC for current state architecture and the progressive state architecture into a DaC that is specific to the third-party DaC tool. An exemplary demo application architecture 900 generated using demo application DaC is shown in FIG. 9. It may be appreciated by those skilled in the art that the demo application architecture shown in FIG. 9 is only exemplary and does not limit the scope of the present disclosure in any manner.

Referring now to FIG. 8 that shows a high-level data flow diagram 800 of a framework proposed in the present disclosure, in accordance with exemplary embodiments. As shown in FIG. 8, the framework includes the visualizer 802, the DSL transformer 804, the model transformer 806, the model generator 808, the DaC transformer 810 and the repository 814. A centralized architecture team 820 may interact with the framework and create a base-DSL which may be stored in the repository 814.

Further, the product architect 822 may interact with the framework via the visualizer 802. The product architect 822 may interact with the visualizer 802 to create or enrich the application-specific DSL. For this purpose, as explained above, the product architect 822 logs in to the visualizer 802 and the base-DSL components are loaded on the visualizer 802. The product architect 822 may then provide the first user input on the visualizer 802 to create the application-specific components. For instance, the product architect 822 may import or drag and drop at least one base-DSL component into the editor at the visualizer 802 to create the application-specific component.

The product architect's 822 input (“first user input”) is then passed on from the visualizer 802 to the DSL transformer 804, which creates the set of application-specific components or objects at the visualizer 802. The set of application-specific components created at the visualizer 802 are converted into the application-specific DSL by the DSL transformer 804. The application-specific DSL components are then stored in the repository 814 and may then be re-used to generate architecture models for the specific application. In an implementation, the application-specific DSL components are approved by the centralized architecture team 820 prior to storing them in the repository 814.

The product architect 822 may also interact with the visualizer 802 to create the progressive state architecture for a new application. For this, the product architect 822 may login to the visualizer 802 to create the model and may access the model creation section of the visualizer 802. A relevant application-specific DSL is then loaded at the visualizer 802 based on the selection made by the product architect 822. Thus, the product architect 822 may choose or select the relevant application-specific DSL which is then loaded into the visualizer 802. This relevant application-specific DSL is that application-specific DSL for which the product architect 822 wishes to create the progressive state architecture. For instance, if the product architect 822 wishes to create a progressive state architecture for a banking application, the product architect 822 may select, from various options visible in the visualizer 802, the application-specific DSL for the specific banking application. Further, this relevant application-specific DSL is loaded into the visualizer 802 by pulling such relevant application-specific DSL from the repository 814.

The product architect 822 may then create the visual representation of the progressive state architecture using the relevant application-specific DSL. This visual representation of the progressive state architecture created by the product architect 822 is then provided as an input to the model transformer 806. The model transformer 806 then transforms the visual representation of the progressive state architecture into the set of model objects. These set of model objects are provided as an input to the model generator 808 where these model objects are converted into a Diagram as Code (“DaC”). The DaC generated by the model generator 808 is then stored in the repository 814.

Another use case of the framework as shown in FIG. 8 is to create the current state architecture of the application. The application metadata of the application is periodically pushed from the at least one software inventory system 812 to the model transformer 806. For example, the application metadata may include but is not limited to, an application identifier (ID), a name, a description, application roles, modules, dependencies, etc.

The model transformer 806 then fetches from the repository 814, the application-specific DSL of the application for which the current state architecture is to be generated. The model transformer 806 then transforms the application metadata into the set of model objects based on the application-specific DSL and invokes the model generator 808. The model generator 808 then generates the current state architecture based on the set of model objects. Essentially, generating the current state architecture includes converting the set of model objects (from step S606) into a Diagram as Code (“DaC”). The DaC generated by the model generator 808 is then stored in the repository 814.

Yet another feature of the framework is determination of the progressive architecture drift between the current state architecture and the progressive state architecture of the application. For this, the model generator 808 receives the progressive state architecture for the application from the repository 814. In an exemplary implementation, the model generator 808 pulls the progressive state architecture DaC of that specific application for which the model generator 808 has generated the current state architecture DaC. In another exemplary implementation, the model generator 808 pulls the progressive state architecture DaC and the current state architecture DaC of any specific (same) application from the repository 814.

The model generator 808 then compares the progressive state architecture and the current state architecture, e.g., the model generator 808 compares the current state architecture DaC and the progressive state architecture DaC. Based on this comparison, the progressive architecture drift is identified by the model generator 808. This difference as calculated or detected by the model generator 808 pertains to design or the progressive architecture drift in the current state architecture and the to-be or progressive state architecture. This progressive architecture drift after being generated may be saved in the repository 814.

The framework also provides the DaC transformer 810 that is capable of converting the current state architecture DaC and for the progressive state architecture DaC (generated by the model generator 808) into the DaC that is specific to the third-party DaC tool. The DaC transformer 810 thus acts as an adapter to convert the DaC generated by the framework into DaC specific to other tools. This allows the framework to be pluggable such that it may be used with other third party DaC tools as well.

The framework also provides a user service Application Programming Interface (API) 818 where the user 824 may login to the framework and retrieve the base-DSL, the application-specific DSL for any application, current state architecture DaC of any application generated by the framework, progressive state architecture DaC for any application generated by the framework, progressive architecture drift between the current state architecture and the progressive state architecture for the application that has been generated or identified by the framework, and the current state architecture DaC and the progressive state architecture DaC specific to the third-party DaC tool that has been generated by the DaC transformer 810.

Additionally, according to an aspect of the present disclosure, a non-transitory computer-readable storage medium storing instructions for creating an application-specific DSL for an application is disclosed. The instructions include executable code which, when executed by a processor, may cause the processor to: load, at a visualizer, a set of base-Domain Specific Language (DSL) components from a repository; receive, at the visualizer, a first user input; create, at the visualizer, a set of application-specific components based on the set of base-DSL components and the first user input; and transform, via a DSL transformer, the set of application-specific components into a set of application-specific DSL components for the application.

Moreover, according to another aspect of the present disclosure, a non-transitory computer-readable storage medium storing instructions for generating a progressive state architecture of an application is disclosed. The instructions include executable code which, when executed by a processor, may cause the processor to: load, at a visualizer, a set of application-specific DSL components from a repository, wherein the set of application-specific DSL components are associated with the application; create, at the visualizer, a visual representation of the progressive state architecture based on a second user input and the set of application-specific DSL components associated with the application; transform, via a model transformer, the visual representation of the progressive state architecture into a set of model objects; and generate, via a model generator, the progressive state architecture of the application based on the set of model objects. Also, the executable code when executed by the processor further causes the processor to generate via the model generator, the progressive state architecture of the application based on the set of model objects by converting the set of model objects into a Diagram as Code (“DaC”). Further, the executable code when executed by the processor further causes the processor to convert via a DaC transformer, the Diagram as Code into a first target DaC.

Also, according to another aspect of the present disclosure, a non-transitory computer-readable storage medium storing instructions for generating a current state architecture of an application is disclosed. The instructions include executable code which, when executed by a processor, may cause the processor to: receive periodically, at a model transformer from at least one software inventory system, an application metadata associated with the application; fetch, via the model transformer from a repository, an application-specific DSL for the application; transform, via the model transformer, the application metadata into a set of model objects based on the application-specific DSL; and generate, via a model generator, the current state architecture of the application based on the set of model objects. Also, the executable code when executed by the processor further causes the processor to generate, via the model generator, the current state architecture of the application based on the set of model objects by converting the set of model objects into a Diagram as Code (“DaC”). Further, the executable code when executed by the processor further causes the processor to convert, via a DaC transformer, the Diagram as Code into a second target DaC.

Further, according to yet another aspect of the present disclosure, a non-transitory computer-readable storage medium storing instructions for determining a progressive architecture drift between a current state architecture and a progressive state architecture of an application is disclosed. The instructions include executable code which, when executed by a processor, may cause the processor to: receive, via a model generator from a repository, the progressive state architecture for the application; compare, via the model generator, the progressive state architecture and the current state architecture; and identify, via the model generator, the progressive architecture drift between the current state architecture and the progressive state architecture of the application based on the comparison.

As is evident from the above disclosure, the solutions provided by the present disclosure are technically advanced as compared to the existing solutions as the framework proposed by the present disclosure is capable of intelligently generating and maintaining architecture design for current state architecture of applications. Further, the framework also provides a means to create or enrich or standardize model Domain Specific Language (DSL). The framework also provides a visual interface that allows product architects 822 to create the progressive state architecture and the application-specific DSL. Furthermore, the framework also has the capability to detect the architecture drifts between the current state architecture and progressive state architecture.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed repository/database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable storage medium or other equivalents and successor media, in which data or instructions may be stored.

Although the present application describes specific embodiments which may be implemented as computer programs or code segments in computer-readable storage media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating an application-specific domain specific language (DSL) for an application, the method being implemented by at least one processor, the method comprising:
loading, by the at least one processor at a visualizer, a set of base-Domain Specific Language (DSL) components from a repository;
receiving, by the at least one processor at the visualizer, a first user input;
creating, by the at least one processor at the visualizer, a set of application-specific components based on the set of base-DSL components and the first user input; and
transforming, by the at least one processor via a DSL transformer, the set of application-specific components into a set of application-specific DSL components for the application.

2. A method for generating a progressive state architecture of an application, the method being implemented by at least one processor, the method comprising:
loading, by the at least one processor at a visualizer, a set of application-specific DSL components from a repository, wherein the set of application-specific DSL components are associated with the application;
creating, by the at least one processor at the visualizer, a visual representation of the progressive state architecture based on a second user input and the set of application-specific DSL components associated with the application;
transforming, by the at least one processor via a model transformer, the visual representation of the progressive state architecture into a set of model objects; and
generating, by the at least one processor via a model generator, the progressive state architecture of the application based on the set of model objects.

3. The method as claimed in claim 2, wherein the generating the progressive state architecture of the application based on the set of model objects comprises converting the set of model objects into a Diagram as Code (“DaC”).

4. The method as claimed in claim 3, further comprising:
converting, by the at least one processor via a DaC transformer, the DaC into a first target DaC.

5. A method for generating a current state architecture of an application, the method being implemented by at least one processor, the method comprising:
receiving periodically, by the at least one processor at a model transformer from at least one software inventory system, an application metadata associated with the application;
fetching, by the at least one processor via the model transformer from a repository, an application-specific Domain Specific Language (DSL) for the application;
transforming, by the at least one processor via the model transformer, the application metadata into a set of model objects based on the application-specific DSL; and
generating, by the at least one processor via a model generator, the current state architecture of the application based on the set of model objects.

6. The method as claimed in claim 5, wherein the generating the current state architecture of the application based on the set of model objects comprises converting the set of model objects into a Diagram as Code (“DaC”).

7. The method as claimed in claim 6, further comprising:
converting, by the at least one processor via a DaC transformer, the DaC into a second target DaC.

8. A method for determining a progressive architecture drift between a current state architecture and a progressive state architecture of an application, the method being implemented by at least one processor, the method comprising:
receiving, by the at least one processor via a model generator from a repository, the progressive state architecture for the application;
comparing, by the at least one processor via the model generator, the progressive state architecture and the current state architecture; and
identifying, by the at least one processor via the model generator, the progressive architecture drift between the current state architecture and the progressive state architecture of the application based on the comparison.
